(19) United States
(12) Patent Application Publication
(10) Pub. No.: US 2004/0078475 A1
(43) Pub. Date: Apr. 22, 2004

(54) Anonymous access to a service

(76) Inventors: Jan Camenisch, Rueschlikon (CH); Michael Waidner, Au (CH); Elsie A. Van Herreweghen, Horgen (CH)

Correspondence Address: Louis J Percello, Intellectual Property Law Department, IBM Corporation, PO Box 218, Yorktown Heights, NY, 10598, US

(21) Appl. No.: 10/432,266

(22) PCT Filed: Nov. 8, 2001
(86) PCT No.: PCT/IB01/02098

(30) Foreign Application Priority Data
Nov. 21, 2000 (EP) 00811105.6

(51) Int. Cl. G06F 15/16

(52) U.S. Cl. 709/229; 713/201

(57) ABSTRACT

A method and a system for providing an anonymous access to a service within a network is disclosed. Thereby a user entity sends a user request comprising access-service information and requested service information to an anonymous-access service. The anonymous-access service verifies whether the access-service information are valid. In the event that the access-service information are valid, the anonymous-access service assigns the access-service information to subscription information and connects to the service by sending a verified request comprising the subscription information and the requested service information. The anonymous-access service receives response-service information from the service and forwards it to the user entity. By doing so, the user's instances of access to the services are not linkable to each other nor are they linkable to the user's real identity.

### TECHNICAL FIELD

The present invention relates a method and system for providing an anonymous access to a service within a network. More particularly, the invention relates to an anonymous access to payment-based and subscription-based web services.

### BACKGROUND OF THE INVENTION

Users become more and more concerned about their privacy when browsing the Internet. Web sites trace users' browsing actions using cookies, for example, and try to accumulate user information. The trading and selling of this information is not adequately controlled by legal regulations, and users are concerned about proliferation and linking of information about their behavior leading to a breach of privacy and possibly discrimination. Studies and examples of the past have shown that this is an unavoidable result of information proliferation being controlled by the industry.

Today, many companies offer information and products via web sites. In many cases, a registration or subscription is required in order to access those sites and in other cases, a payment is involved. In either cases, the user has to leave personal information.

Several online privacy services are available, such as Anonymizer.com (http://www.anonymizer.com) or freedom (http://www.freedom.net), which provide services to take control of privacy on the Internet.

Anonymizer.com, on one hand, offers to their users to browse the web in a private and anonymous fashion, whereby it acts as a portal and conceals the data traffic for their users, e.g., by modifying IP (Internet Protocol) addresses. This anonymizing service presents a single point of trust. The link between a user's identity with an actual transaction being performed, for example web browsing, can sometimes be derived easily by the content of a transaction, e.g. e-mail address.

Freedom, on the other hand, uses a special network, a so-called MIXnet, with which the single point of trust can be overcome. Moreover, online identities called pseudonyms are used. These pseudonyms shall prevent the identification of users through the content of their transactions, like the e-mail addresses.

None of the known techniques and services allow users access anonymously to payment-based or subscription-based web services. This calls for an innovative method that allows users an anonymous access to such services, whereby the user's instances of access to the services are not linkable to each other nor are they linkable to the user's real identity.

### SUMMARY AND ADVANTAGES OF THE INVENTION

The invention discloses a method and system for providing an anonymous access to a service within a network. For that, a user entity sends a user request comprising access-service information and requested service information to an anonymous-access service. The anonymous-access service verifies whether the access-service information are valid. In the event that the access-service information are valid, the anonymous-access service assigns the access-service information to subscription information and connects to the service by sending a verified request comprising the subscription information and the requested service information. The anonymous-access service receives response-service information from the service and forwards it to the user entity.

The anonymous-access service or anonymity service provides access to the service only to user entities, hereinafter short users/user, who have/has the right to access the service. In general, the anonymous-access service allows users to access information anonymously, i.e. the user's instances of access to services are not linkable to each other nor are they linkable to the user's real identity.

The disclosed scheme can be applied to payment-based or subscription-based access, i.e., to services which require users to subscribe, e.g., under use of a user-id and/or password.

Furthermore, the disclosed scheme allows the anonymous-access service to be distributed over several operating entities, thereby reducing requirements of trust by users in an overall service. For example, the anonymous-access service receiving the payment and issuing an anonymous subscription can be an independent organization, e.g., an e-kiosk, and need not be operated by the service providing the response-service information.

The two entities, the anonymous-access service and the service, therefore have to collude to link an actual browsing action, i.e. the access to the service, back to a specific user identity.

The user may be connected to a subscription service by sending an activation information and receiving access information usable as access-service information directly from said subscription service. The sending of the activation information may comprise sending payment activation information in order to initialize a payment transaction. This shows the advantage that the user can pay in advance and receives the access information representing access-service information without having a connection to the service in request.

It is possible to connect prior the user to a registration service, e.g. a certification authority, by sending a credential request information. The user receives then a registration information that can be used to obtain the access information at the subscription service. The access information can be shown as access-service information to the anonymous-access service.

The subscription service and the anonymous-access service can be integrated in a unitary entity. Moreover, the subscription service and the anonymous-access service can be part of the service. By doing so, the infrastructure can be simplified considerably.

The disclosed scheme can be realized using a provably secure pseudonym system, as for example described by D. Chaum in “Security without identication: Transaction systems to make big brother obsolete” in Communications of the ACM, 28(10):1030-1044, October 1985. By applying such a pseudonym system, even collusions between different operating entities will not make the anonymous-access service insecure. In other words, if different functions, such as receiving a payment for a subscription and granting access to the service, are operated by the same entity, then the entity is still not able to link service accesses to subscriptions or to users. This results from the nature of the pseudonym scheme.

The subscription information, that for example comprise an id and/or password specific to a service, can be prestored at the anonymous-access service. Thus, a fast access to the service is available. It is sufficient to store at least one such subscription information for each service.

Moreover, the anonymous-access service may store multiple subscription information in order to provide the service or if the subscription information is requested by the service. In an embodiment the subscription information can be stored in form of a table which can easily be implemented.

The access-service information can be verified by the anonymous-access service in several ways. In one case, parts of the access-service information are prestored such that the anonymous-access service compares the prestored access-service information with an incoming one. Then, this verified access-service information can be assigned to the subscription information.

Furthermore, the access-service information may comprise a showing of a credential or certificate in order to allow the user to prove its right to possess and apply this access-service information.

The requested service information may comprise an Uniform Resource Locator (URL), a requested information, or even a product request.

There are many ways to provide and deploy the subscription information. The subscription information may comprises a cookie, a user-id, or a user-id password.

### DESCRIPTION OF THE DRAWINGS

Preferred embodiments of the invention are described in detail below, by way of example only, with reference to the following schematic drawings.

FIG. 1 shows a schematic illustration of a first embodiment according to the present invention.

FIG. 2 shows a schematic illustration of a second embodiment wherein a subscription service and an anonymous-access service from an unitary entity.

FIG. 3 shows a schematic illustration of a third embodiment wherein a registration service is involved.

The drawings are provided for illustrative purpose only and do not necessarily represent practical examples of the present invention to scale.

Glossary

The following are informal definitions to aid in the understanding of the description.

Credential CRu(AUTH): A credential is understood as a statement about a person or user U (pseudonym) signed by some authority AUTH, e.g. certification authority. The statement can be, for instance, this person or user U is allowed to drive a car, or this person or user U is eligible for a credit. In some systems, the authority AUTH only sees a blinded version of the credential.

Public key certificate: A public key certificate or short certificate is a credential, where the signed statement says “this public key belongs to the person or user U”.

Credential show [symbol] CRu(AUTH): A credential show is a message that, depending on the system, comprises the credential CRu(AUTH) or a proof of possession of the credential CRu(AUTH).

### DESCRIPTION OF EMBODIMENTS

With general reference to the figures, the features of a method and system for providing an anonymous access to a service within a network are described in the following.

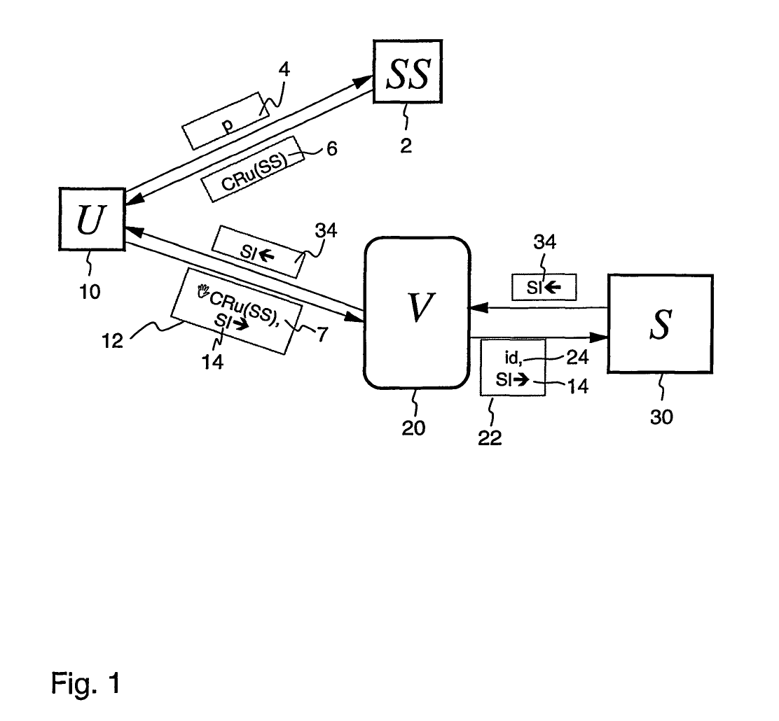

FIG. 1 shows a basic scenario that allows a user entity 10, labeled with U and hereafter short user 10, to anonymously access a service 30, labeled with S. Such a user entity 10 can be any device suitable to perform actions and connect to a network, such as a computer, a handheld device, a mobile phone etc.. It is assumed that the service 30 is a subscription-based service 30, for instance, an archive service providing information, e.g. articles. For the sake of simplicity, only one such service 30 is depicted in the figure whilst many of them are usually around the network. The user 10 is connected to an anonymous-access service 20. The anonymous-access service 20 is further connected to the subscription-based service 30. The connections are available via a network as it is known in the art, e.g. the Internet. The arrows in the figure show the flow of information or messages sent, whereby the labeled boxes indicate those information. Moreover, the user 10 is connected to a subscription service 2, which can be a subscription server or host. The user 10 initiates a payment by sending an appropriate payment message 4, labeled with p, as indicated by the arrow. This payment message 4 may include the wish to use a particular subscription-based 30 or different subscription-based services 30. This payment message 4 may also comprise an intended number or time frame for the accesses. In answer to the payment message 4, the user 10 receives access information 6, which comprise here an anonymous credential 6, labeled with CRu(SS), for use with the anonymous-access service 20. This anonymous credential 6 allows the user 10 to prove to the anonymous-access service 20 that the user 10 has a valid subscription. The subscription can be free of charge, in which case the subscription service 2 grants CRu(SS) free of payment.

The user 10 sends to the anonymous-access service 20 a user request 12 comprising access-service information 7, which comprise here an anonymous credential show 7 and requested service information 14, which for example requests an article from a defined newspaper at the subscription-based service 30. This is indicated by box 12 labeled with [symbol] CRu(SS), SI→. The anonymous-access service 20 is adapted to accept such an anonymous credential show 7 proving the user's 10 or holder's legitimate subscription. Upon verification of the anonymous credential show 7, by the anonymous-access service 20, the anonymous-access service 20 retrieves the information in request, i.e. response-service information 34, from the subscription-based service 30 and sends it to the user 10, as indicated by box 34 labeled with SI←. For that, the anonymous-access service 20 connects to the subscription-based service 30 by sending a verified request 22, labeled with id, SI→. This verified request 22 comprises subscription information 24 and the requested service information 14. In response to the requested service information 14, the subscription-based service 30 returns the response-service information 34, e.g., the requested article. As indicated above, the anonymous-access service 20 receives this response-service information 34 and forwards it to the user 10.

The subscription information 24, that can be an id (identifier), can be stored, for example within a table, in advance at the anonymous-access service 20 or can be requested on demand from a particular service 30, that as well as can be a database, by the anonymous-access service 20. It is also possible, that services 30, which wish to cooperate with the anonymous-access service 20, send their subscription information 24 to the anonymous-access service 20 in order to provide a fast access from the anonymous-access service 20 to the service 30.

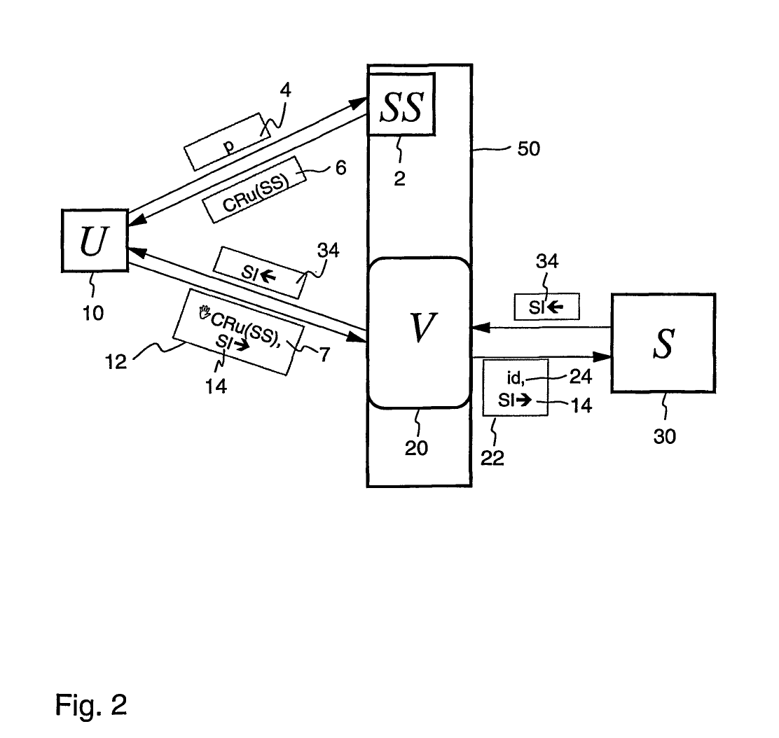

It shall be mentioned that the access information 6 and the related access-service information 7 may also represent a pseudonym or pseudonym-password pair recognized by the subscription service 2 and the anonymous-access service 20. Such a pair is then not known to the subscription-based services 30. Such implementation would have some security limitations which, however, can be diminished as described with reference to FIG. 2.

FIG. 2 shows an illustration of a second embodiment wherein the subscription service 2 and the anonymous-access service 20 form an unitary entity 50, a so-called web portal 50. The same reference numerals are used to denote the same or like parts and their functions. Current services 30 or other subscription-based services 30 do not support the verification feature of the anonymous-access service 20 used to allow pseudonymous or anonymous access. A collected anonymizing services can then be operated as part of a web portal 50 and eventually integrated as part of a web server product. The subscription service 2 and the anonymous-access service 20 (subscription and verification services SS and V) form together the web portal 50. In this case, the web portal 50 itself communicates with the actual server of the service 30 over the Internet. This has the advantage, that the user 10 has to connect only to one single point, the web portal 50, for the actions described above.

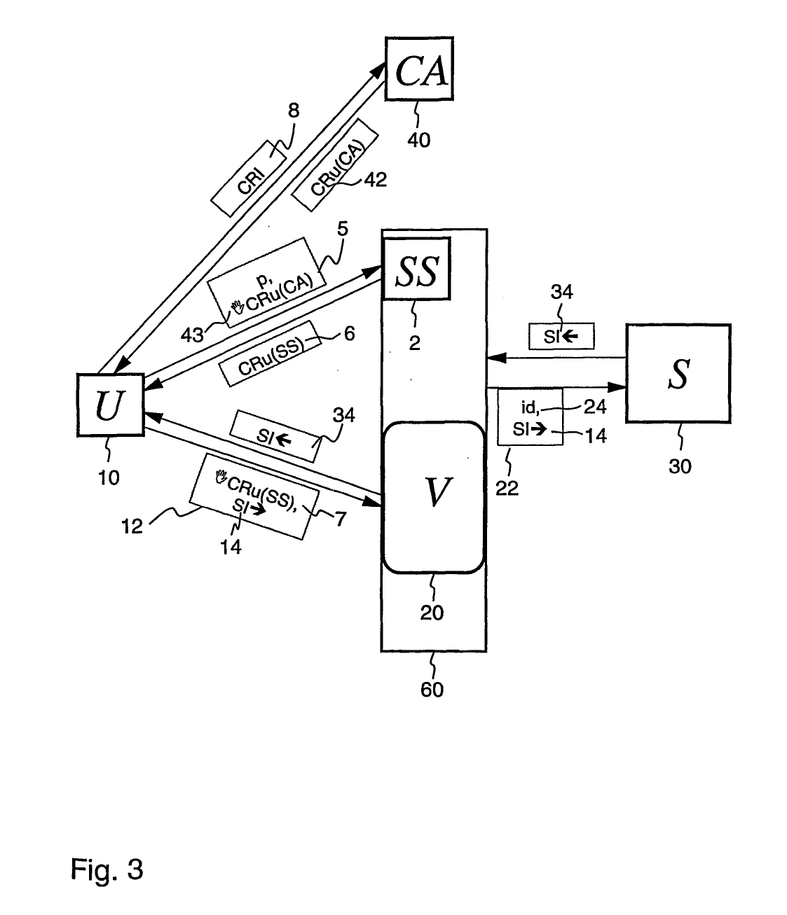

FIG. 3 shows a schematic illustration of a third embodiment using a specific pseudonym system. The structure of this embodiment is generally similar to the embodiment described with reference to FIG. 2 and only the key differences will be described here. Firstly, as illustrated in the figure, the subscription service 2 and the anonymous-access service 20 form an unitary service entity 60. A further notable difference here is that a registration service 40, labeled with CA, is involved. This registration service 40 can be a certification authority. Furthermore, the registration service 40 can be integrated in the unitary service entity 60, but here the registration service 40 is an external or separate entity as depicted in the figure. The user 10 connects to the registration service 40 by sending a credential request information 8, labeled with CRI. In answer to it, the user 10 receives a registration information, which comprise a root pseudonymous credential 42, labeled and indicated with CRu(CA), from the registration service 40. The root pseudonymous credential 42 can be an anonymous or pseudonymous credential 42. Such anonymous or pseudonymous credentials 42 useable with the anonymous-access service 20 can be realized using different possible pseudonym systems. Depending on which pseudonym system used, implementation aspects as well as security/anonymity features may change.

The following describes a possible realization of an anonymity service, such as the anonymous-access service 20, using a provably secure pseudonym system such as described by A. Lysyanskaya, R. Rivest, A. Sahai, and S. Wolf in their article “Pseudonym systems” in H. Heys and C. Adams, editors, Selected Areas in Cryptography, volume 1758 of Lecture Notes in Computer Science, Springer Verlag, 1999. In a chosen pseudonym system, the pseudonym system's certification authority, i.e. the registration service 40, registers users or the user 10 to the pseudonym system by issuing them with the root pseudonymous credential 42, as indicated by the arrow and box labeled with CRu(CA). The user 10 sends to the unitary service entity 60 a message comprising a root pseudonymous credential show 43 together with payment as indicated by box 5, labeled with p, [symbol] CRu(CA). The unitary service entity 60, and in particular the subscription service 2 as part of the unitary service entity 60, issues then the access information 6 comprising the subscription credential 6, labeled with CRu(SS), to the user 10. Then, the user 10 can send the subscription credential show 7, i.e. [symbol] CRu(SS), every time the user 10 requests information from the subscription-based service 30.

In the above chosen pseudonym system, showing a credential, such as the subscription credential show 7, is not linkable to what was seen by the issuing party, i.e. the registration service 40 or the subscription service 2. As an example, even if the registration service 40 and the unitary service entity 60 with its subscription service 2 and the anonymous-access service 20 cooperate and exchange information, they are not able to link a request for information, i.e. the user request 12 comprising the subscription credential show 7, to a user 10 registered with the registration service 40, or to data collected by these entities and services during the issuing of the root pseudonymous credential 42, i.e. CRu(CA) or the subscription credential 6, i.e. CRu(SS).

As a result, even if the registration service 40 and the unitary service entity 60 with its subscription service 2 and the anonymous-access service 20 are implemented as part of the web portal 50, as described above, would be operated by one entity (e.g., by one company for example), the user 10 need not trust this company in order to be convinced of his total anonymity when accessing the subscription-based service 30.

The embodiments can be designed with slightly different variations. For example, a pay-per-page or pay-per-URL mechanism may be implemented. This can be achieved by the following. The subscription credential 6 comprises e-money or e-cash for access the service 30. Showing the subscription credential show 7 within the user request 12 represents a payment for the specific URL (Uniform Resource Locator).

Any disclosed embodiment may be combined with one or several of the other embodiments shown and/or described. This is also possible for one or more features of the embodiments.

The present invention can be realized in hardware, software, or a combination of hardware and software. Any kind of computer system—or other apparatus adapted for carrying. out the method described herein—is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

1. A method for providing an anonymous access to a service (30) within a network, the method comprising the steps of:
connecting a user entity (10) to an anonymous-access service (20) by sending a user request (12) comprising access-service information (7) and requested service information (14);
verifying by said anonymous-access service (20) whether said access-service information (7) are valid and in the event that said access-service information (7) are valid connecting said anonymous-access service (20) to said service (30), the connecting step comprising,
sending to said service (30) a verified request (22) comprising subscription information (24) and said requested service information (14);
receiving from said service (30) response-service information (34) in response to said requested service information (14);
forwarding said response-service information (34) by said anonymous-access service (20) to said user entity (10).

2. A method for providing an anonymous access to a service (30) within a network, the method comprising the steps of:
receiving from a user entity (10) a user request (12) comprising access-service information (7) and requested service information (14);
verifying whether said access-service information (7) are valid and in the event that said access-service information (7) are valid
connecting to said service (30), the connecting step comprising,
sending a verified request (22) comprising subscription information (24) and said requested service information (14);
receiving response-service information (34) in response to said requested service information (14);
forwarding said response-service information (34) to said user entity (10).

3. A method for providing an anonymous access to a service (30) within a network, the method comprising the steps of:
receiving from an anonymous-access service (20) a verified request (22) comprising subscription information (24) and requested service information (14), whereby said anonymous-access service (20) receives from a user entity (10) a user request (12) comprising access-service information (7) and said requested service information (14), and assigns said access-service information (7) to said subscription information (24) if said access-service information (7) are valid;
sending response-service information (34) in response to said requested service information (14) to said anonymous-access service (20) that forwards it to said user entity (10).

4. A method for providing an anonymous access to a service (30) within a network, the method comprising the steps of:
sending a user request (12) comprising access-service information (7) and requested service information (14) to an anonymous-access service (20),
whereby said anonymous-access service (20) verifies whether said access-service information (7) are valid and assigns said access-service information (7) to subscription information (24) if said access-service information (7) are valid,
said anonymous-access service (20) connects to said service (30) by
sending a verified request (22) comprising said subscription information (24) and said requested service information (14) and
receiving response-service information (34) in response to said requested service information (14),
said anonymous-access service (20) forwards said response-service information (34); receiving said response-service information (34) from said anonymous-access service (20).

5. A method according to any of the preceding claims comprising connecting the user entity (10) to a subscription service (2) by sending activation information (4) and receiving access information (6) that being usable as the access-service information (7).

6. A method according to claim 5, whereby the step of sending an activation information (4) comprises sending payment activation information (4) to perform a payment transaction.

7. A method according to any of the preceding claims comprising connecting the user entity (10) to a registration service (40) by sending a credential request information (8) and receiving a registration information (42), said registration information (42) being usable to obtain access information (6).

8. A method according to any of the preceding claims comprising prestoring the subscription information (24) at the anonymous-access service (20).

9. The method according to the claims 1 or 2, whereby the step of verifying whether said access-service information (7) are valid comprises assigning the access-service information (7) to the subscription information (24).

10. A computer program element comprising program code means for performing a method of any one of the claims 1 to 9 when said program is run on a computer.

11. A computer program product stored on a computer usable medium, comprising computer readable program means for causing a computer to perform a method according to anyone of the preceding claims 1 to 9.

12. A system for providing an anonymous access within a network comprising:
a user entity (10);
an anonymous-access service (20) being connectable to said user entity (10);
a service (30) being connectable to said anonymous-access service (20),
wherein said user entity (10) is adapted to send, in use, a user request (12) comprising access-service information (7) and requested service information (14) to said anonymous-access service (20), said anonymous-access service (20) verifies whether said access-service information (7) are valid and in the event that said access-service information (7) are valid assigns said access-service information (7) to subscription information (24) and connects to said service (30) by sending a verified request (22) comprising said subscription information (24) and said requested service information (14), said anonymous-access service (20) receives response-service information (34) from said service (30) and forwards it to said user entity (10).

13. A system according to claim 12 further comprising a subscription service (2) being connectable to said user entity (10).

14. A system according to claim 13, wherein the subscription service (2) and the anonymous-access service (20) are integrated in a unitary entity (50).

15. A system according to claim 12, wherein the subscription service (2) and the anonymous-access service (20) are part of the service (30).

16. A system according to any of the preceding claims 12 to 15, wherein the access-service information (7) comprises a credential.

17. A system according to any of the preceding claims 12 to 15, wherein the access-service information (7) comprises a certificate.

18. A system according to any of the preceding claims 12 to 15, wherein the subscription information (24) are prestored.

19. A system according to any of the preceding claims 12 to 15, wherein the requested service information (14) comprises an Uniform Resource Locator (URL).

20. A system according to any of the preceding claims 12 to 15, wherein the subscription information (24) comprises a cookie, a user-id, or a user-id password.

21. A system according to any of the preceding claims 12 to 15, wherein the service (30) comprises a subscription-based service (30).

22. A system according to any of the preceding claims 12 to 15, wherein the service (30) comprises a payment-based service (30).
